(19) United States
(12) Patent Application Publication
(10) Pub. No.: US 2018/0373205 A1
(43) Pub. Date: Dec. 27, 2018

(54) ELAPSED TIME INDICATOR

(71) Applicant: UWI Technology Limited, Edinburgh (GB)

(72) Inventors: Peter HIGGINS, Edinburgh (GB); Sergey GORDEYEV, Edinburgh (GB); David MCILVENNA, Edinburgh (GB)

(21) Appl. No.: 15/776,104

(22) PCT Filed: Nov. 17, 2016
(86) PCT No.: PCT/GB2016/053587

§ 371 Date: May 15, 2018

(30) Foreign Application Priority Data
Nov. 17, 2015 (GB) 1520227.8

(51) Int. Cl. G04F 13/06

(52) U.S. Cl. CPC G04F 13/06

(57) ABSTRACT

An elapsed time indicator comprises a porous element, an electrical source, and an electronic controller. The electronic controller is configured to receive electrical power from the electrical source and cause a fluid to be received by the porous element in response to expiry of a predetermined time period. The predetermined time period may be associated with an item such as a perishable item with which the elapsed time indicator is to be associated or to which the elapsed time indicator is to be attached. The predetermined time period may comprise a lifetime or a shelf-life of the item or a predetermined proportion of a lifetime or a shelf-life of the item.

### FIELD

An elapsed time indicator is described herein for measuring and indicating an elapsed time for use, in particular though not exclusively, in a label.

### BACKGROUND

It is known to use microfluidic elapsed time indicators for indicating expiry of a time period such as a lifetime or shelf-life associated with an item such as a perishable item. It is also known to incorporate microfluidic elapsed time indicators into a label for attachment to an item or for attachment to a container for an item. The precision of the measurement of the elapsed time using such known microfluidic elapsed time indicators may not be accurate enough for some fields of use. Furthermore, the visual indication provided on expiry of a time period using such known microfluidic elapsed time indicators may not be sufficiently visible for some fields of use.

It is also known to use simple electronic elapsed time indicators for indicating expiry of a time period such as a lifetime or shelf-life associated with an item such as a perishable item. It is known to incorporate such simple electronic elapsed time indicators into labels for attachment to an item or for attachment to a container for an item. Such simple electronic elapsed time indicators may provide a binary indication on expiry of a time period. Such simple electronic elapsed time indicators generally require batteries to provide sufficient electrical energy to power some timing electronics and an electronic display. Such simple electronic elapsed time indicators may, however, be too costly to manufacture for some fields of use.

### SUMMARY

One or more features of any one of the following aspects or embodiments may apply alone or in any combination in relation to any of the other aspects or embodiments.

According to a first aspect or embodiment there is provided an elapsed time indicator, comprising:

a porous element;

an electrical source; and

an electronic controller which is configured to:
receive electrical power from the electrical source; and
cause a fluid to be received by the porous element in response to expiry of a predetermined time period.

The predetermined time period may be associated with an item with which the elapsed time indicator is to be associated or to which the elapsed time indicator is to be attached. The predetermined time period may comprise a lifetime or a shelf-life of the item or a predetermined proportion of a lifetime or a shelf-life of the item.

Upon receiving the fluid, the porous element may be impregnated by the fluid.

The fluid may comprise an oil or a mixture of oils.

The fluid may comprise silicon oil.

The porous element may be sheet-like.

The porous element may comprise fibres such as cellulose fibres.

The porous element may comprise paper such as filter paper.

The elapsed time indicator may comprise a reservoir of the fluid.

The electronic controller may be configured to control a flow of the fluid from the reservoir to the porous element on expiry of the predetermined time period.

The elapsed time indicator may comprise a deformable membrane which defines the reservoir of the fluid.

The elapsed time indicator may comprise a microfluidic channel providing a fluid flow path from the reservoir to the porous element.

The elapsed time indicator may comprise a valve which is configured to initially prevent the flow of the fluid from the reservoir along the microfluidic channel to the porous element and to selectively allow the flow of the fluid from the reservoir along the microfluidic channel to the porous element under the control of the electronic controller.

The valve may comprise a micro-valve.

The valve may be electrically actuated.

Such an elapsed time indicator may consume less power than an all-electronic elapsed time indicator since the only power consumed is that required for the one-time operation of the valve.

The valve may comprise an electro-thermal valve.

The valve may comprise a movable valve member which is movable between a first configuration in which the valve member occludes the microfluidic channel and a second configuration in which the valve member allows the fluid to flow along the microfluidic channel.

The valve may comprise a heating element which is defined on or adjacent to the valve member and which extends at least part-way around a perimeter of the valve member when the valve member is in the first configuration.

The heating element may be operable so as to melt a portion of the valve member upon which the heating element is defined or to which the heating element is adjacent.

The controller may selectively drive an electric current through the heating element so as to resistively heat the heating element and selectively melt the portion of valve member upon which the heating element is defined or to which the heating element is adjacent. The magnitude and/or the duration of the electric current may be selected according to a material of the valve member.

The heating element may comprise a metal.

The valve member may be formed from an electrically insulating material.

The valve member may be formed from a material which has a melting point of less than 100° C., of between 50° C. and 70° C., of between 55° C. and 65° C., or of between 59° C. and 61° C.

The valve member may be formed from a material which comprises a polymer.

The valve member may be formed from a material which comprises at least one of a parylene material, PET and PMMA.

The valve member may be formed from a material which comprises a wax.

The valve member may be formed from a material which comprises paraffin wax.

The valve may be actuated using at least one of a piezoelectric, electrostatic, thermo-pneumatic, pneumatic, hydraulic and a magnetic effect.

The valve may comprise a hydrogel.

The elapsed time indicator may comprise a body which defines a cavity, which cavity defines and/or contains the reservoir of the fluid, the microfluidic channel and the porous element.

The body may comprise one or more layers.

The cavity may be initially sealed but is configured to be selectively exposed to an environment external to the elapsed time indicator.

The body may define a reservoir vent extending from the cavity at or adjacent to the reservoir.

The reservoir vent may be initially sealed but may be configured to be selectively unsealed to provide a flow path for air between the cavity and the environment external to the elapsed time indicator to thereby permit the fluid to flow from the reservoir towards the porous element.

The body may define an indicator vent extending from the cavity at or adjacent to the porous element.

The indicator vent may be initially sealed but may be configured to be selectively unsealed to provide a flow path for air between the cavity and the environment external to the elapsed time indicator to thereby permit the fluid to flow from the reservoir towards the porous element.

The reservoir vent and the indicator vent may be configured to be selectively unsealed at the same time.

The reservoir vent and the indicator vent may be configured to be selectively unsealed at different times.

The reservoir vent and the indicator vent may be configured to be selectively unsealed in response to the same activation event.

The reservoir vent and the indicator vent may be configured to be selectively unsealed in response to different activation events.

The elapsed time indicator may comprise an activation member detachably attached to the body so as to initially seal at least one of the reservoir vent and the indicator vent.

At least one of the reservoir vent and the indicator vent may be unsealed by detaching the activation member from the body.

The body of the elapsed time indicator may be attachable to a first part of a container and wherein the activation member may be attachable to a second part of the container such that opening the container for the first time by relative movement of the first and second parts of the container causes the activation member to be detached from the body and at least one of the reservoir vent and the indicator vent to be unsealed to thereby permit the fluid to flow from the reservoir towards the porous element.

The elapsed time indicator may comprise an activation member which is detachably attached to the body so as to initially seal one of the reservoir vent and the indicator vent, and wherein the reservoir vent and the indicator vent are connected by a channel for air which is defined separately from the microfluidic channel such that detaching the activation member from the body unseals both the reservoir vent and the indicator vent to thereby permit the fluid to flow from the reservoir towards the porous element.

The channel for air may be defined by the body.

One of the reservoir vent and the indicator vent may be permanently open and the other of the reservoir vent and the indicator vent may be configured to be selectively unsealed to provide a flow path for air between the cavity and the environment external to the elapsed time indicator to thereby permit the fluid to flow from the reservoir towards the porous element.

The elapsed time indicator may comprise a reservoir vent activation member detachably attached to the body so as to initially seal the reservoir vent.

The reservoir vent may be unsealed by detaching the reservoir vent activation member from the body.

The elapsed time indicator may comprise an indicator vent activation member detachably attached to the body so as to initially seal the indicator vent.

The indicator vent may be unsealed by detaching the indicator vent activation member from the body.

The elapsed time indicator may comprise a solid agent located adjacent to or on the porous element and a heating element for melting the solid agent, wherein the electronic controller is configured to selectively activate the heating element so as to melt the solid agent and form the fluid in response to expiry of the predetermined time period.

The solid agent may be deposited or otherwise formed, near, adjacent to, or on the porous element.

The heating element may be located near, adjacent to, or on the solid agent.

The fluid may be colourless or clear.

Upon impregnation by the fluid, the porous element may become transparent or more transparent.

The elapsed time indicator may comprise an indicator element which becomes visible or more visible through the porous element when the porous element becomes transparent or more transparent.

The indicator element may be coloured, for example green or red.

Such an elapsed time indicator may measure elapsed time more accurately than microfluidic elapsed time indicators because the measurement of the elapsed time is essentially independent of the properties of the fluid and/or of the porous element. In particular, the measurement of the elapsed time is essentially independent of the viscosity of the fluid and the porosity and permeability of the porous element. The measurement of elapsed time may also be independent of the orientation of the elapsed time indicator. The display is not limited to a colour defined by known chemical reactions.

The fluid may be coloured.

The fluid may be green or red.

The elapsed time indicator may comprise a plurality of porous elements, wherein the electronic controller is configured to cause a corresponding fluid to be received by a final one of the porous elements in response to expiry of the predetermined time period and to cause a corresponding fluid to be received by each of the other porous elements in response to expiry of a corresponding intermediate predetermined time period.

Each of the corresponding intermediate predetermined time periods may be a predetermined proportion of the predetermined time period.

Upon receiving the corresponding fluid, each porous element may be impregnated by the corresponding fluid.

The elapsed time indicator may comprise a reservoir of the fluid, wherein each porous element selectively receives fluid from the fluid reservoir.

The elapsed time indicator may comprise one reservoir for each porous element, wherein each porous element selectively receives fluid from a corresponding reservoir.

The elapsed time indicator may comprise a plurality of solid agents and a plurality of heating elements, each heating element being configured for melting a corresponding one of the solid agents, wherein the electronic controller is configured to selectively activate each heating element so as to melt the corresponding solid agent and form a fluid in response to expiry of the corresponding predetermined time period.

Each solid agent may be deposited or otherwise formed, near, adjacent to, or on the corresponding porous element.

Each heating element may be located near, adjacent to, or on the corresponding solid agent.

Each fluid may be colourless or clear.

Upon impregnation by a corresponding fluid, each porous element may become transparent or more transparent.

The elapsed time indicator may comprise one indicator element for each porous element, each indicator element being generally aligned with a corresponding one of the porous elements so as to become visible or more visible through the corresponding porous element when the corresponding porous element becomes transparent or more transparent.

Each of the indicator elements may be coloured.

Two or more of the indicator elements may have the same colour.

Two or more of the indicator elements may have a different colour.

One or more of the indicator elements may be green.

One or more of the indicator elements may be red.

The indicator elements may be defined or formed on a common substrate.

The indicator elements may be formed by printing different areas of a common substrate.

Each fluid may be coloured.

Two or more of the fluids may have the same colour.

Two or more of the fluids may have different colours.

One or more of the fluids may be green.

One or more of the fluids may be red.

The elapsed time indicator may comprise a cover layer defining an opaque area and a transparent window area through which the porous element is visible.

The cover layer may be plain in colour, for example, white.

The cover layer may have one or more symbols, characters, letters, numbers or graphical representations printed or otherwise defined thereon.

The elapsed time indicator may be flexible.

The elapsed time indicator may comprise a substrate.

The substrate may be flexible.

At least one of the porous element, the electrical source, and the electronic controller may be mounted on the substrate.

The substrate may define one or more electrical inter-connections between the electrical source and the electronic controller.

At least one of the electrical source and the electronic controller may be flexible.

The electrical source may comprise a battery.

The electrical source may be rechargeable.

The elapsed time indicator may comprise an inductive element for wireless recharging of the electrical source.

The electrical source may be formed by printing.

At least one of the electrical source and the electronic controller is rigid.

The electronic controller may be programmable.

The electronic controller may store or define the predetermined time period.

The electronic controller may initiate a measurement of elapsed time in response to connection of the electronic controller to the electrical source for the first time.

The elapsed time indicator may comprise comprising a first elapsed time indicator part and a second first elapsed time indicator part, wherein the first and second first elapsed time indicator parts are detachably attached to one another.

Separation of the first and second first elapsed time indicator parts for the first time may cause the electronic controller to initiate the measurement of the elapsed time.

Separation of the first and second first elapsed time indicator parts for the first time may cause the electronic controller to be connected to the electrical source.

The first elapsed time indicator part may be configured for attachment to a first object and the second elapsed time indicator part may be configured for attachment to a second object.

The electronic controller may automatically initiate the measurement of the elapsed time in response to relative movement between the first and second elapsed time indicator parts for the first time.

The elapsed time indicator may comprise comprising a switch arrangement, wherein operation of the switch arrangement causes the electronic controller to initiate the measurement of the elapsed time.

The switch arrangement may be configured for manual operation.

The switch arrangement may be operable mechanically.

The switch arrangement may comprise a normally-open or normally-off switch arrangement.

The switch arrangement may comprise a first switch part provided with one of the first and second elapsed time indicator parts and a second switch part provided with the other of the first and second elapsed time indicator parts.

The switch arrangement may comprise a pair of electrical contacts and an electrically insulating activation member, wherein the electrical contacts are mechanically biased towards one another and the electrically insulating activation member is removably inserted between the pair of electrical contacts so that removal of the electrically insulating activation member from between the pair of electrical contacts causes the pair of electrical contacts to move into contact with one another.

The switch arrangement may be electrically connected between the electrical source and the electronic controller.

The electronic controller may comprise a memory.

The electronic controller may be configured to store a value of the predetermined time period in the memory.

The electronic controller may be configured to store a value of each of the intermediate predetermined time periods in the memory.

The electronic controller may be configured for wireless communications with an external apparatus.

The electronic controller may be configured for uni- or bi-directional wireless communications with the external apparatus.

The electronic controller may be configured to wirelessly receive a trigger signal from the external apparatus and to initiate measurement of the elapsed time on receipt of the trigger signal.

The electronic controller may be configured to wirelessly receive a value of the predetermined time period from the external apparatus and to store the value of the predetermined time period in the memory.

The electronic controller may be configured to wirelessly receive a value of each of the intermediate predetermined time periods from the external apparatus and to store the values of the intermediate predetermined time periods in the memory.

The electronic controller may be configured to wirelessly transmit a signal to the external apparatus on expiry of the predetermined time period.

The electronic controller may be configured to wirelessly transmit a signal to the external apparatus on expiry of each of the intermediate predetermined time periods.

The elapsed time indicator may comprise an environmental sensor for measuring at least one environmental parameter, wherein the electronic controller is configured to repeatedly receive measured values of the at least one environmental parameter from the environmental sensor.

The electronic controller may be configured to repeatedly adjust the stored predetermined time period according to the measured values of the at least one environmental parameter.

The electronic controller may be configured to convey an alarm signal when a measured value of the at least one environmental parameter falls outside a corresponding predetermined range.

The alarm signal may be visual.

The alarm signal may be provided by providing the fluid to one or more of the porous elements.

The electronic controller may be configured to convey the alarm signal by providing the fluid to one or more of the porous elements so as to provide a distinctive pattern or appearance.

The alarm signal may be audible.

The elapsed time indicator may comprise an audio device such as a speaker for providing the alarm signal.

The alarm signal may include information relating to the location of the elapsed time indicator. Such an alarm signal may allow the elapsed time indicator to be located, for example, within a storage area or a warehouse or the like. Such an alarm signal may allow an item or a container for an item with which the elapsed time indicator is located or to which the elapsed time indicator is attached, to be located within a storage area or a warehouse or the like.

The electronic controller may be configured to wirelessly transmit the alarm signal to the external apparatus when a measured value of the at least one environmental parameter falls outside a corresponding predetermined range.

The external apparatus may be configured to emit, transmit, display, broadcast, and/or disseminate a further alarm signal in response to receipt of the alarm signal. The further alarm signal may be visual and/or audible.

The environmental parameter may comprise at least one of temperature, pressure, humidity, pH, vibration, shock, orientation and location.

The electronic controller may comprise a microcontroller.

The electronic controller may comprise a timer.

The electronic controller may comprise an oscillator.

The electronic controller may comprise a crystal.

The elapsed time indicator may comprise an adhesive layer for attaching the elapsed time indicator to an object.

The elapsed time indicator may have a thickness of less than or equal to 1 mm.

The elapsed time indicator may have a length of less than or equal to 100 mm.

The elapsed time indicator may have a width of less than or equal to 10 mm.

According to a second aspect or embodiment there is provided a kit of parts for an elapsed time indicator, comprising:

a porous element; and

an electronic controller,

wherein the kit of parts is capable of being assembled to form an elapsed time indicator such that the electronic controller is configured to:

receive electrical power from an electrical source; and

cause a fluid to be received by the porous element in response to expiry of a predetermined time period.

The kit of parts may comprise the electrical source.

According to a third aspect or embodiment there is provided a label comprising an elapsed time indicator, comprising:

a porous element;

an electrical source; and

an electronic controller which is configured to:
receive electrical power from the electrical source; and
cause a fluid to be received by the porous element in response to expiry of a predetermined time period.

According to a fourth aspect or embodiment there is provided a method for indicating an elapsed time, comprising

providing electrical power from an electrical source to an electronic controller; and

using the electronic controller to cause a fluid to be received by a porous element in response to expiry of a predetermined time period.

The method may comprise using the electronic controller to control the fluid to flow from a reservoir to the porous element in response to expiry of the predetermined time period.

The method may comprise using the electronic controller to selectively heat and melt a solid agent located adjacent to or on the porous element and form the fluid in response to expiry of the predetermined time period.

### BRIEF DESCRIPTION OF THE DRAWINGS

An elapsed time indicator will now be described by way of non-limiting example only with reference to the following drawings of which:

FIG. 1 is a schematic perspective view of an elapsed time indicator before activation;

FIG. 2 is a schematic system diagram of the elapsed time indicator of FIG. 1;

FIG. 3 is a cross-section on AA of FIG. 2 of the elapsed time indicator of FIG. 1 before activation;

FIG. 4(a) is a cross-section on BB of FIG. 2 of the elapsed time indicator of FIG. 1 before activation;

FIG. 4(b) is a cross-section on BB of FIG. 2 of the elapsed time indicator of FIG. 1 after expiry of a predetermined time period from activation;

FIG. 5(a) is a cross-section on CC of FIG. 4(a) of the elapsed time indicator of FIG. 1 before activation;

FIG. 5(b) is a cross-section on CC of FIG. 4(b) of the elapsed time indicator of FIG. 1 after expiry of a predetermined time period from activation;

FIG. 6(a) is a schematic plan view of the elapsed time indicator of FIG. 1 immediately after activation;

FIG. 6(b) is a schematic plan view of the elapsed time indicator of FIG. 1 after elapse of a first time period after activation;

FIG. 6(c) is a schematic plan view of the elapsed time indicator of FIG. 1 after elapse of a second time period after activation;

FIG. 6(d) is a schematic plan view of the elapsed time indicator of FIG. 1 after elapse of a third time period after activation;

FIG. 7(a) is a schematic illustration of the elapsed time indicator of FIG. 1 attached to a two-part container before opening of the container for the first time so as to activate the elapsed time indicator;

FIG. 7(b) is a schematic illustration of the elapsed time indicator of FIG. 1 immediately after opening the two-part container for the first time so as to activate the elapsed time indicator;

FIG. 8 is a schematic system diagram of a first alternative elapsed time indicator before activation;

FIG. 9 is a schematic system diagram of a second alternative elapsed time indicator before activation;

FIG. 10 is a schematic system diagram of a third alternative elapsed time indicator before activation;

FIG. 11 is a schematic system diagram of a fourth alternative elapsed time indicator before activation;

FIG. 12 is a cross-section on AA of the fourth alternative elapsed time indicator of FIG. 11;

FIG. 13(a) is a schematic plan view of a fifth alternative elapsed time indicator immediately after activation;

FIG. 13(b) is a schematic plan view of the fifth alternative elapsed time indicator of FIG. 13(a) after elapse of a first time period after activation; and

FIG. 13(c) is a schematic plan view of the fifth alternative elapsed time indicator of FIG. 13(a) after elapse of a second time period after activation.

### DETAILED DESCRIPTION OF THE DRAWINGS

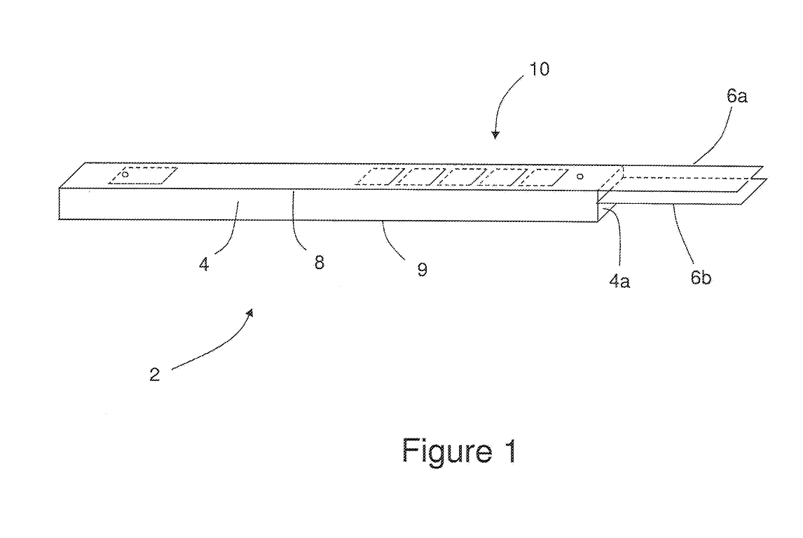

Referring initially to FIG. 1 there is shown an elapsed time indicator generally designated 2 for use in a label for an object (not shown) such as a perishable item or a container for a perishable item. The elapsed time indicator 2 includes a body 4, a first activation member 6a and a second electrically insulating activation member 6b. The first activation member 6a is detachably attached to an upper surface 8 of the body 4. The second activation member 6b is detachably attached to an end 4a of the body 4. In some embodiments, the activation members 6a, 6b may be unitary. The elapsed time indicator 2 further includes a display arrangement generally designated 10 for providing a visual indication of elapsed time after detachment of the activation members 6a, 6b from the body 4. The body 4 includes an adhesive layer (not shown explicitly in FIG. 1) on its lower surface 9 for attachment of the body 4 to an object (not shown). The body 4 is flexible to allow the body 4 to conform to the shape of a variety of different objects.

One of ordinary skill in the art should understand that the elapsed time indicator 2 is illustrated schematically in FIG. 1 and that the relative proportions of the elapsed time indicator 2 may be significantly different to those represented in FIG. 1. In particular, the thickness of the elapsed time indicator 2 (i.e. the height or dimension of the elapsed time indicator 2 in the vertical direction in FIG. 1 has been exaggerated in the interests of clarity.

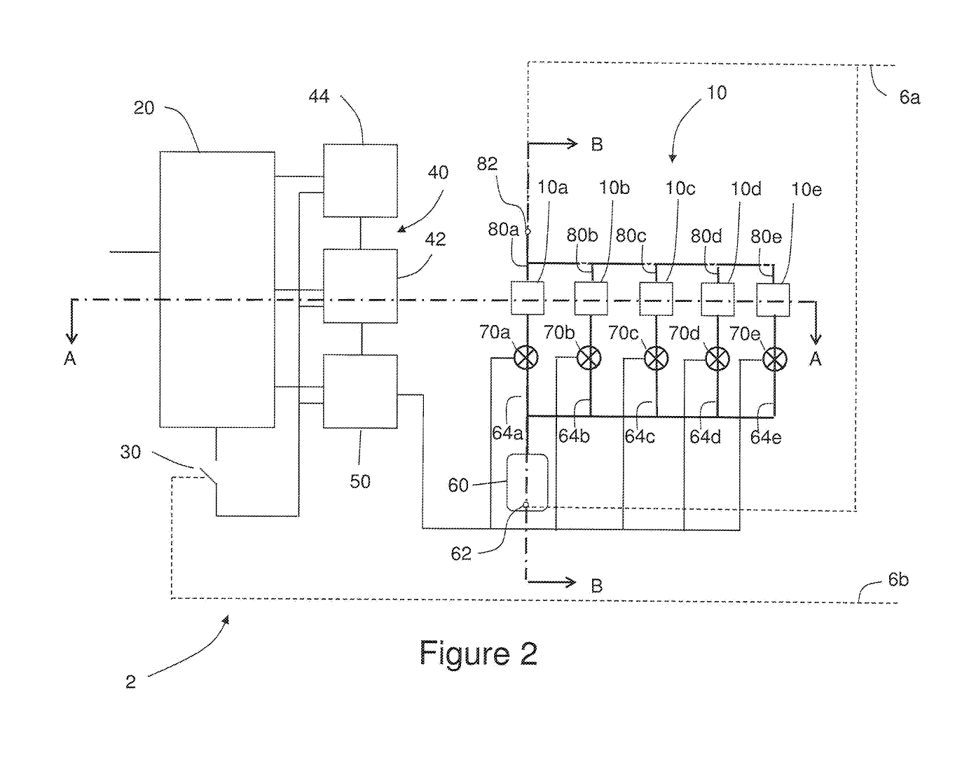

FIG. 2 shows a schematic system diagram of the elapsed time indicator 2 indicating the connectivity between various features of the elapsed time indicator 2. One of ordinary skill in the art should understand that the elapsed time indicator 2 is illustrated schematically in FIG. 2 and that the actual physical positions and/or orientations of any of the features of the elapsed time indicator 2 may be different to those illustrated in FIG. 2. The elapsed time indicator 2 includes a display arrangement 10 includes a plurality of display elements 10a, 10b, 10c, 10d and 10e. Although not shown explicitly in FIG. 2, the first four display elements 10a, 10b, 10c, 10d are configured to selectively display a green colour, whereas the fifth display element 10e is configured to selectively display a red colour.

The elapsed time indicator 2 further includes an electrical source in the form of a flexible printed battery 20, a normally-open switch arrangement 30, and an electronic controller 40. The electronic controller 40 includes a programmable microcontroller 42, a clock crystal 44 and driver circuitry 50. The microcontroller 42 is programmed with a first intermediate predetermined time period, a second intermediate predetermined time period, a third intermediate predetermined time period, a fourth intermediate predetermined time period and a fifth and final predetermined time period which may be selected according to the intended field of use of the elapsed time indicator 2. The fifth and final predetermined time period may, for example, represent a lifetime or a shelf-life of an item such as a perishable item with which the elapsed time indicator 2 is to be associated or to which the elapsed time indicator 2 is to be attached. The first intermediate, second intermediate, third intermediate, and fourth intermediate predetermined time periods may each represent a different predetermined proportion of the final predetermined time period.

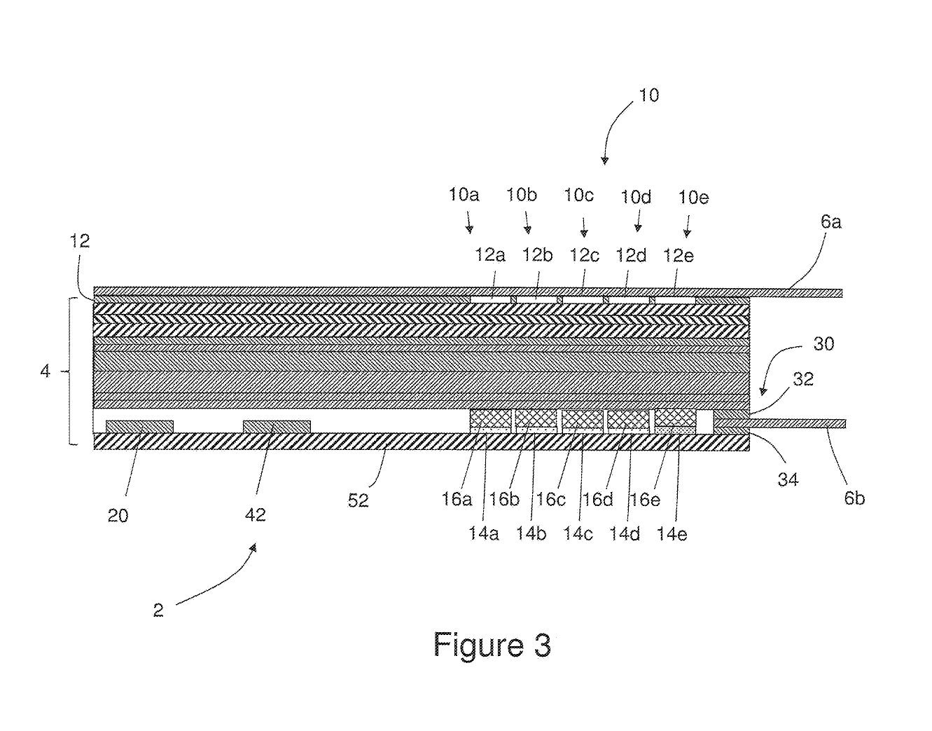

As shown in FIG. 3, the normally-open switch arrangement 30 includes a pair of electrical contacts 32, 34 which are biased mechanically towards one another. Prior to activation of the elapsed time indicator 2, the electrically insulating activation member 6b extends between the electrical contacts 32, 34 so as to prevent an electrical connection therebetween as shown in FIGS. 1 and 3 so that the battery 20 is initially disconnected from the microcontroller 42, the clock crystal 44 and the driver circuitry 50 as shown in FIG. 2. The battery 20, the normally-open switch arrangement 30, the microcontroller 42, the clock crystal 44 and the driver circuitry 50 are all mounted on a flexible substrate 52. The flexible substrate 52 includes a plurality of electrical conductors such as metal tracks (not shown) which define electrical connections between the battery 20, the normally-open switch arrangement 30, the microcontroller 42 and the clock crystal 44 and the driver circuitry 50 so as to realise the electrical circuit shown schematically in FIG. 2.

Referring back to FIG. 2, the elapsed time indicator 2 includes a reservoir 60 of fluid in the form of colourless silicon oil, a reservoir vent 62 and a plurality of microfluidic channels 64a, 64b, 64c, 64d and 64e. Each microfluidic channel 64a, 64b, 64c, 64d, 64e provides a corresponding fluid flow path between the reservoir 60 and a corresponding one of the display elements 10a, 10b, 10c, 10d, 10e. The elapsed time indicator 2 includes a plurality of valves 70a, 70b, 70c, 70d and 70e. Each valve 70a, 70b, 70c, 70d, 70e is configured to selectively control a flow of fluid in a corresponding one of the microfluidic channels 64a, 64b, 64c, 64d, 64e to a corresponding one of the display elements 10a, 10b, 10c, 10d, 10e.

The elapsed time indicator 2 includes a plurality of channels or paths for air flow 80a, 80b, 80c, 80d and 80e and an indicator vent 82. Each air flow path 80a, 80b, 80c, 80d, 80e provides a corresponding air flow path between a corresponding one of the display elements 10a, 10b, 10c, 10d, 10e and the indicator vent 82.

As shown in FIG. 3, the body 4 of the elapsed time indicator 2 further includes a cover layer 12 which is generally opaque but which defines a plurality of transparent windows 12a, 12b, 12c, 12d and 12e extending through a thickness of the cover layer 12. Each display element 10a, 10b, 10c, 10d, 10e includes a corresponding one of the transparent windows 12a, 12b, 12c, 12d, 12e. Each display element 10a, 10b, 10c, 10d, 10e further includes a corresponding coloured indicator element 14a, 14b, 14c, 14d, 14e, wherein each coloured indicator element 14a, 14b, 14c, 14d, 14e is mounted or formed, for example, by printing on the substrate 52. Although not shown explicitly in FIG. 3, it should be understood that the first four indicator elements 14a, 14b, 14c, 14d are green, whereas the fifth indicator element 14e is red. Each display element 10a, 10b, 10c, 10d, 10e further includes a corresponding porous element 16a, 16b, 16c, 16d, 16e. Each porous element 16a, 16b, 16c, 16d, 16e is located adjacent to, or is mounted on, a corresponding one of the indicator elements 14a, 14b, 14c, 14d, 14e. Each porous element 16a, 16b, 16c, 16d, 16e is initially opaque or substantially opaque.

The body 4 of the elapsed time indicator 2 further includes various other layers located between the cover layer 12 and the porous elements 16a, 16b, 16c, 16d, 16e. Unless otherwise indicated below, it should be understood that these other layers are generally transparent and are generally non-porous and/or impervious to the fluid.

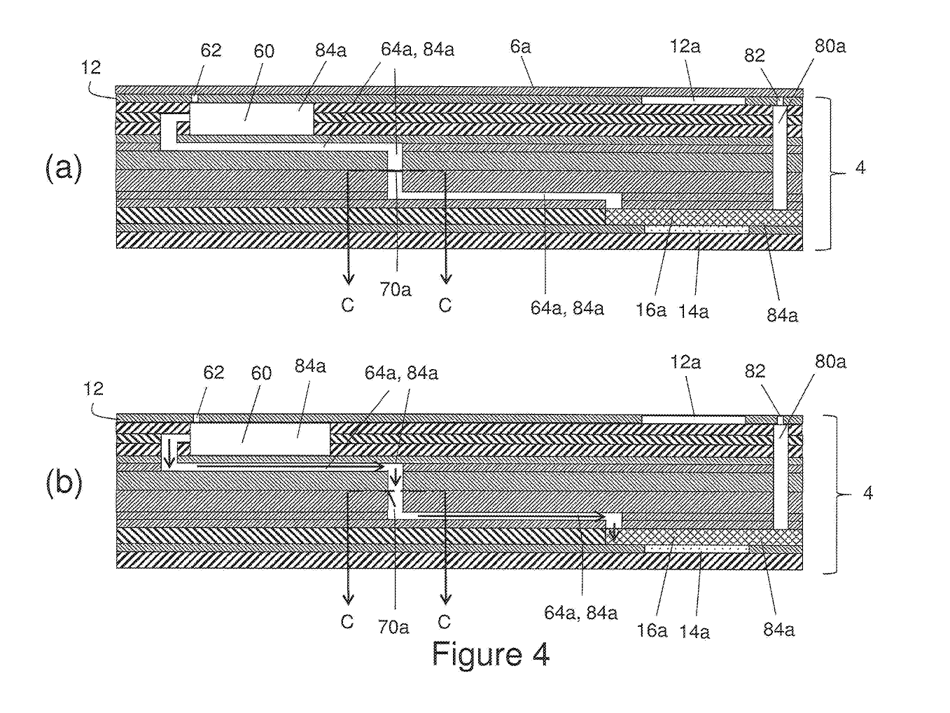

FIG. 4(a) is a cross-section through the elapsed time indicator 2 showing the reservoir 60, the porous element 16a, the microfluidic channel 64a and the valve 70a prior to activation of the valve 70a. As shown in FIG. 4(a), the layers of the body 4 define the microfluidic channel 64a between the reservoir 60 and the porous element 16a such that the microfluidic channel 64a includes one or more sections that extend parallel to the layers of the body 4 and one or more sections that extend perpendicular the layers of the body 4. The body 4 defines a first cavity 84a which defines and/or contains the reservoir 60, the porous element 16a, the microfluidic channel 64a and the valve 70a. The cavity 84 is initially sealed from an environment 86 external to the elapsed time indicator 2 by virtue of the first activation member 6a. As will be described in more detail below, the cavity 84 is selectively connected to the environment 86 via the vents 62, 82 on detachment of the first activation member 6a from the body 4.

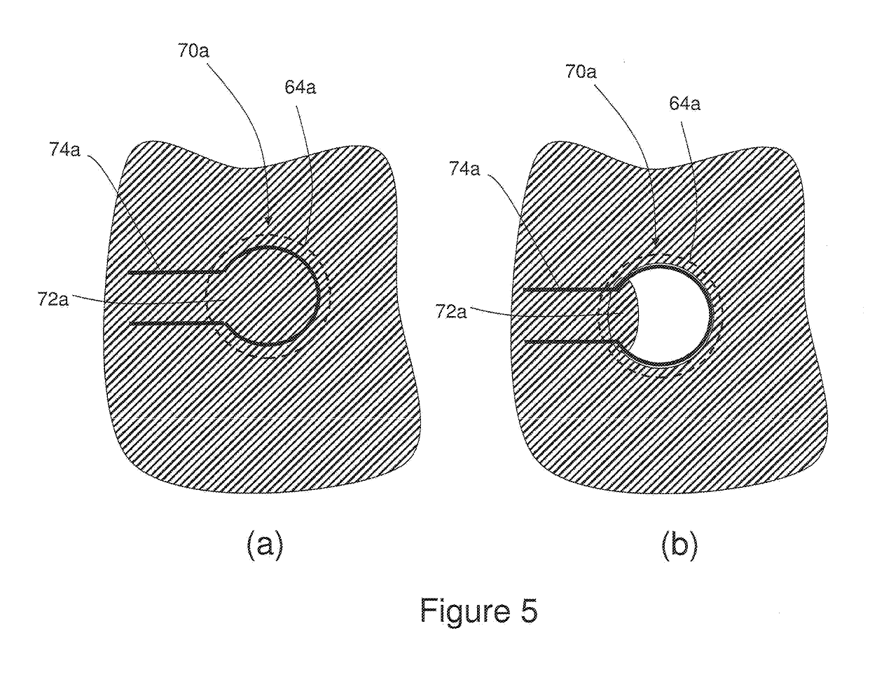

As shown in FIG. 5(a), the valve 70a is defined in a perpendicular section of the microfluidic channel 64a. Specifically, the valve 70a includes a valve member 72a and a metal heating element 74a formed thereon. The valve member 72a is formed from a low melting point polymer material such as parylene, PET or PMMA or from a low melting point wax such a paraffin wax. As shown in FIG. 2, the driver circuitry 50 is electrically connected to the heating element 74a for the supply of an electrical current thereto. It should be understood that the valves 70a, 70b, 70c, 70d, 70e are all identical in structure and operation.

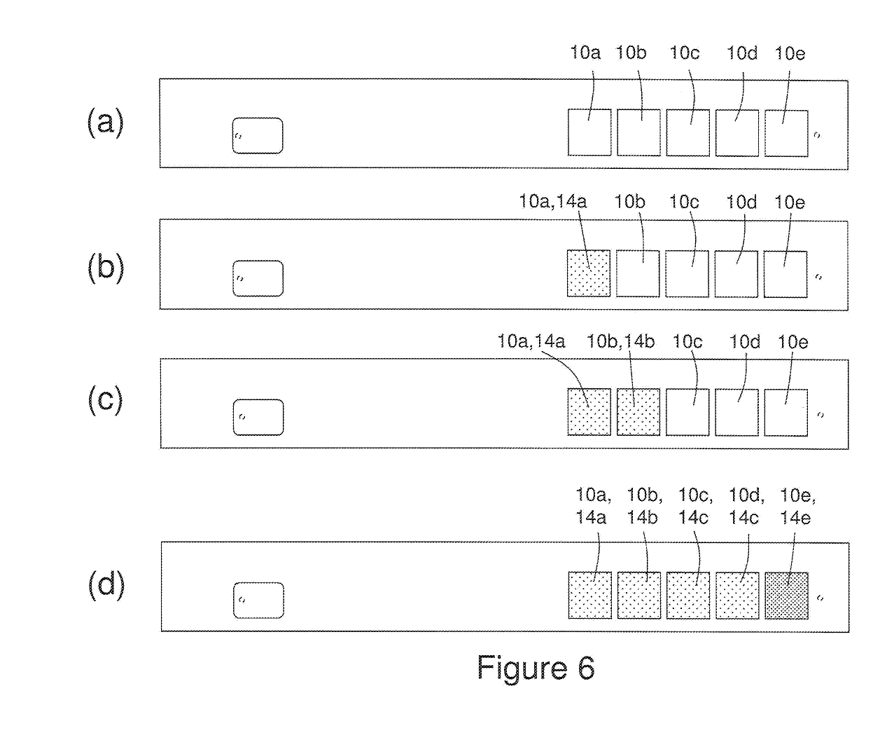

In use, the microcontroller 42 receives electrical power from the battery 20 and controls the valves 70a, 70b, 70c, 70d, 70e according to the result of a comparison between a timing signal received from the clock crystal 44 and the intermediate predetermined time periods and the final predetermined time period stored in the microcontroller 42 so as to provide a quantitative progressive visual indication towards the final predetermined time period. Activation is achieved by detaching the activation members 6a, 6b (represented schematically by the dashed lines in FIG. 2) from the body 4. Specifically, detaching the activation member 6a unseals the vents 62, 82. Detaching the activation member 6b allows the electrical contacts 32, 34 of the normally-open switch arrangement 30 to move into contact thereby activating the elapsed time indicator 2 by connecting the battery 20 to the microcontroller 42, the clock crystal 44 and the driver circuitry 50. Upon the microcontroller 42 receiving power from the battery 20, the microcontroller 42 initiates a timer (not shown) according to the timing signal received from the clock crystal 44. Immediately after activation, as shown in FIG. 6(a), none of the display elements 10a, 10b, 10c, 10d, 10e are activated. Specifically, all of the valves 70a, 70b, 70c, 70d, 70e are closed thereby preventing flow of the silicon oil from the reservoir 60 to the porous elements 16a, 16b, 16c, 16d, 16e.

On expiry of the first intermediate predetermined time period following activation, the microcontroller 42 controls the driver circuitry 50 causing the driver circuitry 50 to supply a sufficient electric current to the heating element 74a of the first valve 70a over a sufficient time period to cause the portion of the valve member 72a under the heating element 74a to melt and a portion of the valve member 72a to pivot open as shown in FIGS. 4(b) and 5(b). Capillary action then causes the silicon oil to move from the reservoir 60 to the first porous element 16a via the microfluidic channel 64a as indicated by the arrows in FIG. 4(b). Vent 62 is open to allow air to move into the reservoir 60 to replace the silicon oil as it moves out of the reservoir 60. Similarly, vent 82 is open to allow air to move ahead of the silicon oil as it moves out of the reservoir 60. The silicon oil reaches the first porous element 16a in a relatively short time period, typically of the order of minutes whereupon the silicon oil laterally impregnates the first porous element 16a in a further relatively short time period, also typically of the order of minutes. On impregnation, the first porous element 16a becomes transparent or more transparent so that the corresponding first green indicator element 14a becomes visible through the corresponding first transparent window 12a and the intervening transparent or substantially transparent layers of the body 4 as shown in FIG. 6(b).

Since the time taken for the silicon oil to (i) move from the reservoir 60 to the first porous element 16a; and then (ii) impregnate the first porous element 16a so as to render the first porous element 16a transparent or more transparent, is only of the order of minutes and the first intermediate predetermined time period is generally a period of several hours or more, one of ordinary skill in the art will understand that the timing of the appearance of the first green indicator element 14a is essentially determined by the microcontroller 42.

On expiry of the second intermediate predetermined time period following activation, the microcontroller 42 controls the driver circuitry 50 causing the driver circuitry 50 to supply a sufficient electric current to the heating element 74b of the second valve 70b over a sufficient time period to cause the second valve 70b to open in the same manner as the first valve 70a already described above. Capillary action then causes the silicon oil to move from the reservoir 60 to the second porous element 16b via the microfluidic channel 64b. The silicon oil reaches the second porous element 16b in a relatively short time period, typically of the order of minutes whereupon the silicon oil laterally impregnates the second porous element 16b in a further relatively short time period, also typically of the order of minutes. On impregnation, the second porous element 16b becomes transparent or more transparent so that the corresponding second green indicator element 14b becomes visible through the corresponding second transparent window 12b and the intervening transparent or substantially transparent layers of the body 4 as shown in FIG. 6(c).

Similarly, on expiry of the third and fourth intermediate predetermined time periods following activation, the microcontroller 42 causes the third and fourth green indicator elements 14c, 14d to become visible through the corresponding third and fourth transparent windows 12c, 12d in a similar manner. Similarly, on expiry of the fifth and final predetermined time period following activation, the microcontroller 42 causes the fifth and final red indicator element 14e to become visible through the corresponding fifth transparent window 12e as shown in FIG. 6(d). The appearance of the fifth and final red indicator element 14e may then indicate that the lifetime or the shelf-life of the item with which the elapsed time indicator 2 is associated or to which the elapsed time indicator 2 is attached has expired.

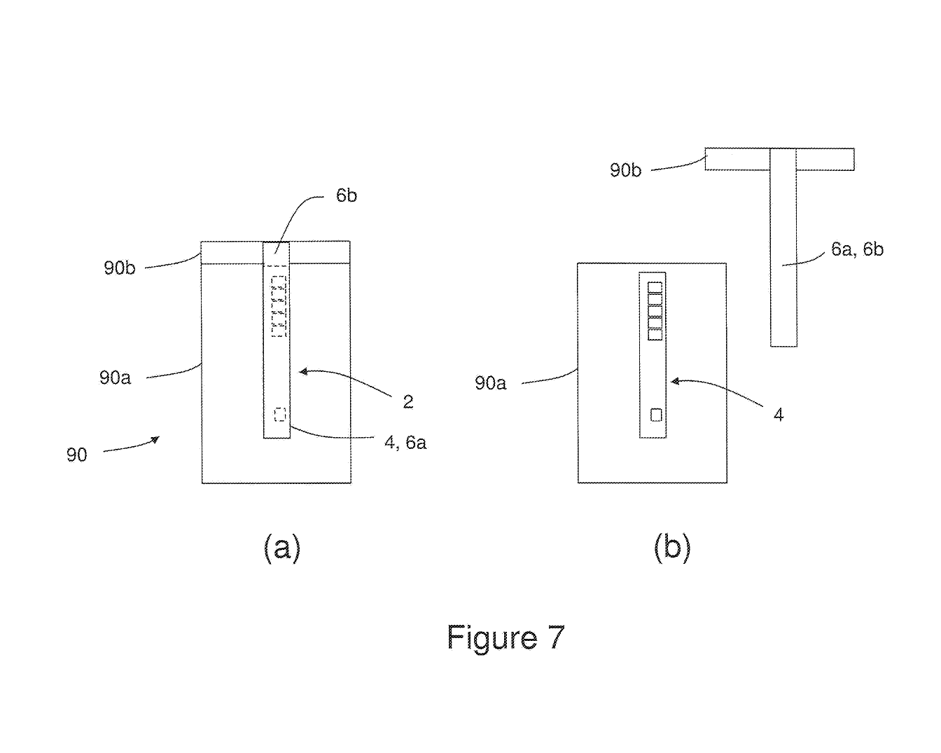

FIGS. 7(a) and 7(b) illustrate the use of the elapsed time indicator 2 for use in monitoring the time elapsed from opening a container 90 for the first time. As shown in FIGS. 7(a) and 7(b), the container 90 includes two parts, namely a container body 90a and a container lid 90b. The lower surface 9 of the body 4 of the elapsed time indicator 2 includes an adhesive layer for attachment of the lower surface 9 of the body 4 to the container body 90a. Similarly, the activation members 6a, 6b each include an adhesive layer for attachment of the activation members 6a, 6b to the container lid 80b. The elapsed time indicator 2 may be configured as, or may form part of, a label for attachment to the container 90. On opening the container 90 for the first time and separating the container lid 90b from the container body 90a for the first time the activation members 6a, 6b remain attached to the container lid 90b but are detached from the body 4 which remains attached to the container body 90a as shown in FIG. 7(b) unsealing the reservoir and indicator vents 62, 82 and triggering the microcontroller 42 to begin measuring the elapsed time as previously described above. As such, the elapsed time indicator 2 may provide a progressive indication of the time elapsed from opening the container 90 for the first time and/or a progressive indication of the time remaining until expiry of the contents of the container 90.

Alternatively, the container body 90a and the container lid 90b may be unitary but may still be movable relative to one another so as to detach the activation members 6a, 6b from the body 4 on opening the container 90 for the first time. For example, the container body 90a and the container lid 90b may be unitary but may be pivotable relative to one another so as to detach the activation members 6a, 6b from the body 4 on opening the container 90 for the first time.

Alternatively, the body 4 could be attached to the container lid 90b and the activation members 6a, 6b could be attached to the container body 90a.

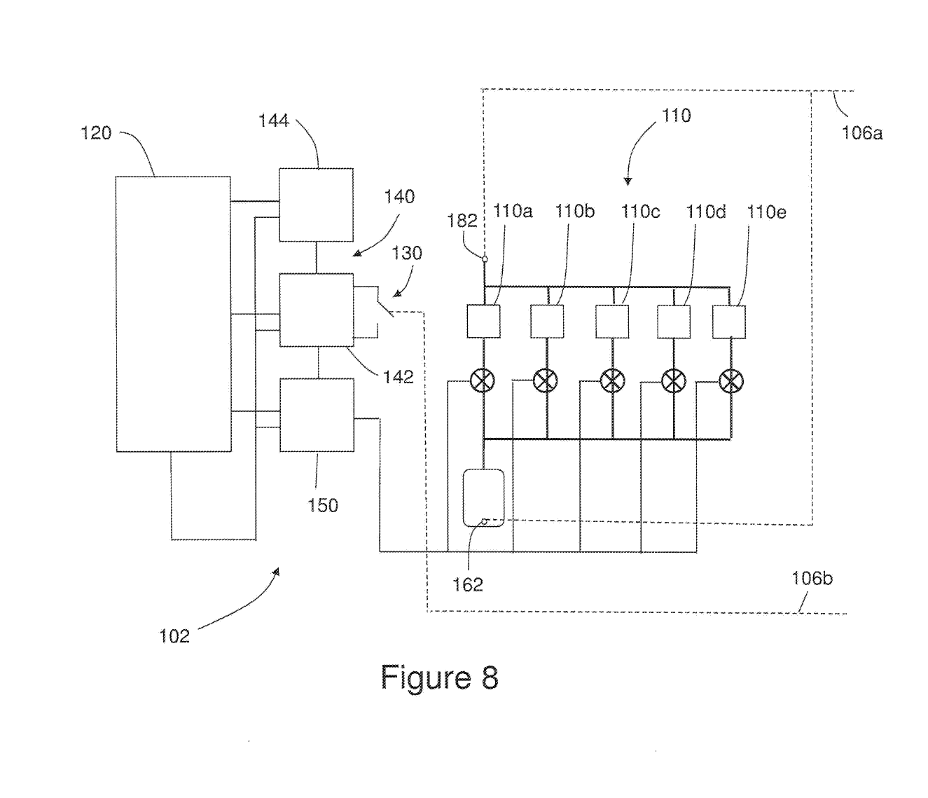

FIG. 8 shows a schematic system diagram of a first alternative elapsed time indicator 102 which shares many like features with the elapsed time indicator 2 of FIGS. 1-7(b). Like features of the elapsed time indicator 102 of FIG. 8 have the same reference numerals as the corresponding features of the elapsed time indicator 2 of FIGS. 1-7(b) incremented by “100”. Specifically, the elapsed time indicator 102 includes a display arrangement 110 which includes a plurality of display elements 110a, 110b, 110c, 110d and 110e. The elapsed time indicator 102 further includes an electrical source in the form of a flexible printed battery 120, a normally-open switch arrangement 130 and an electronic controller 140. The electronic controller 140 includes a programmable microcontroller 142, a clock crystal 144 and driver circuitry 150. The microcontroller 142 is programmed with a first intermediate predetermined time period, a second intermediate predetermined time period, a third intermediate predetermined time period, a fourth intermediate predetermined time period and a fifth and final predetermined time period which may be selected according to the intended field of use of the elapsed time indicator 102. The fifth and final predetermined time period may, for example, represent a lifetime or a shelf-life of an item such as a perishable item with which the elapsed time indicator 102 is to be associated or to which the elapsed time indicator 102 is to be attached. The first, second, third, and fourth intermediate predetermined time periods may each represent a different predetermined proportion of the final predetermined time period. Unlike the elapsed time indicator 2 of FIGS. 1-7(b), the battery 120 is permanently connected to the microcontroller 142, the clock crystal 144 and the driver circuitry 150, and the normally-open switch arrangement 130 is connected only to the microcontroller 142.

Activation is achieved by detaching the activation member 106a (represented schematically by the dashed lines in FIG. 8) so as to unseal vents 162, 182 and detaching the activation member 106b so as to close the switch arrangement 130. Closing the switch arrangement 130 provides a trigger signal to the microcontroller 142 which then initiates a timer (not shown) according to a timing signal received from the clock crystal 144. In all other respects the operation of the elapsed time indicator 102 of FIG. 8 is identical to that of the elapsed time indicator 2.

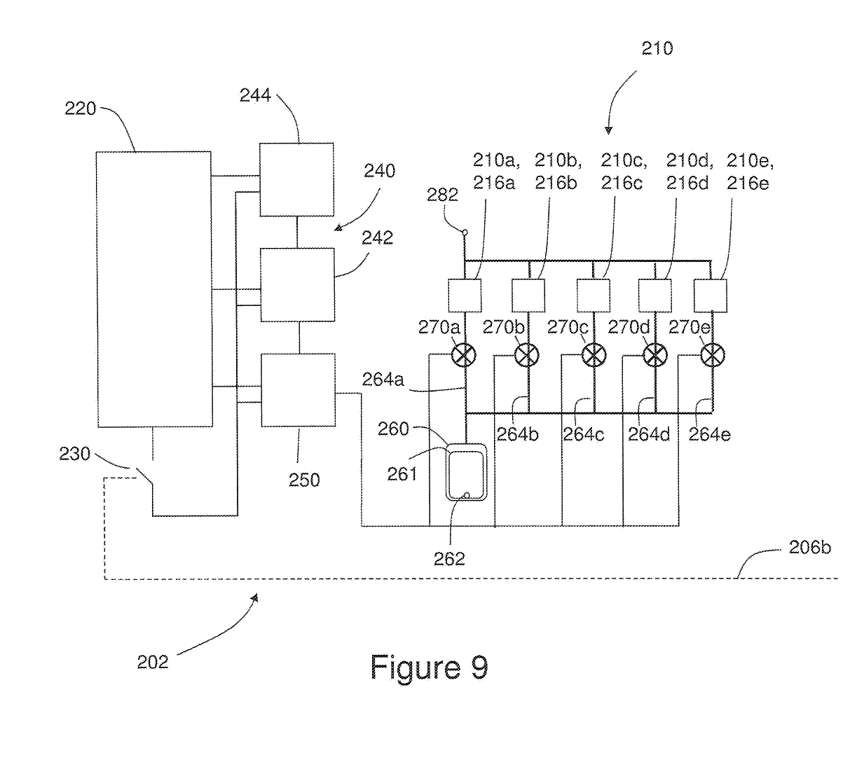

FIG. 9 shows a schematic system diagram of a second alternative elapsed time indicator 202 which shares many like features with the elapsed time indicator 2 of FIGS. 1-7(b). Like features of the elapsed time indicator 202 of FIG. 9 have the same reference numerals as the corresponding features of the elapsed time indicator 2 of FIGS. 1-7(b) incremented by “200”. Specifically, the elapsed time indicator 202 includes a display arrangement 210 which includes a plurality of display elements 210a, 210b, 210c, 210d and 210e. The elapsed time indicator 202 further includes an electrical source in the form of a flexible printed battery 220, a normally-open switch arrangement 230 and an electronic controller 240. The electronic controller 240 includes a programmable microcontroller 242, a clock crystal 244 and driver circuitry 250. The microcontroller 242 is programmed with a first intermediate predetermined time period, a second intermediate predetermined time period, a third intermediate predetermined time period, a fourth intermediate predetermined time period and a fifth and final predetermined time period which may be selected according to the intended field of use of the elapsed time indicator 202. The fifth and final predetermined time period may, for example, represent a lifetime or a shelf-life of an item such as a perishable item with which the elapsed time indicator 202 is to be associated or to which the elapsed time indicator 202 is to be attached. The first, second, third, and fourth intermediate predetermined time periods may each represent a different predetermined proportion of the final predetermined time period.

Unlike the elapsed time indicator 2 of FIGS. 1-7(b), the elapsed time indicator 202 includes a deformable reservoir membrane 261 located within a reservoir cavity 260 defined by a body (not shown) of the elapsed time indicator 202. The reservoir membrane 261 contains the fluid and is in fluid flow communication with a plurality of microfluidic channels 264a, 264b, 264c, 264d, 264e. The elapsed time indicator 202 further includes a reservoir vent 262 which extends from the environment external to the elapsed time indicator 202 to the reservoir cavity 260 and which is permanently open to permit air to flow from the external environment to the reservoir cavity 260. Similarly, the elapsed time indicator 202 further includes an indicator vent 282 which connects each of the porous elements 216a, 216b, 216c, 216d, 216e to the external environment and which is permanently open.

Activation is achieved by detaching the activation member 206b (represented schematically by the dashed line in FIG. 9) so as to close the switch arrangement 230. Closing the switch arrangement 230 provides a trigger signal to the microcontroller 242 which initiates a timer (not shown) according to a timing signal received from the clock crystal 244. On expiry of the first intermediate predetermined time period following activation, the microcontroller 242 controls the driver circuitry 250 causing the driver circuitry 250 to supply an electric current to the heating element of the first valve 270a causing the first valve 270a to open. Capillary action then causes the silicon oil to move from the reservoir membrane 261 to the first porous element 216a via the microfluidic channel 264a causing the deformable reservoir membrane 261 to collapse progressively. Reservoir vent 262 allows air to move into the reservoir cavity 260 to fill the space in the reservoir cavity 260 that was previously occupied by the deformable reservoir membrane 261 prior to collapse. Similarly, indicator vent 282 is open to allow air to move ahead of the silicon oil as it moves out of the reservoir membrane 261. In all other respects, the operation of the elapsed time indicator 202 of FIG. 9 is identical to that of the elapsed time indicator 2.

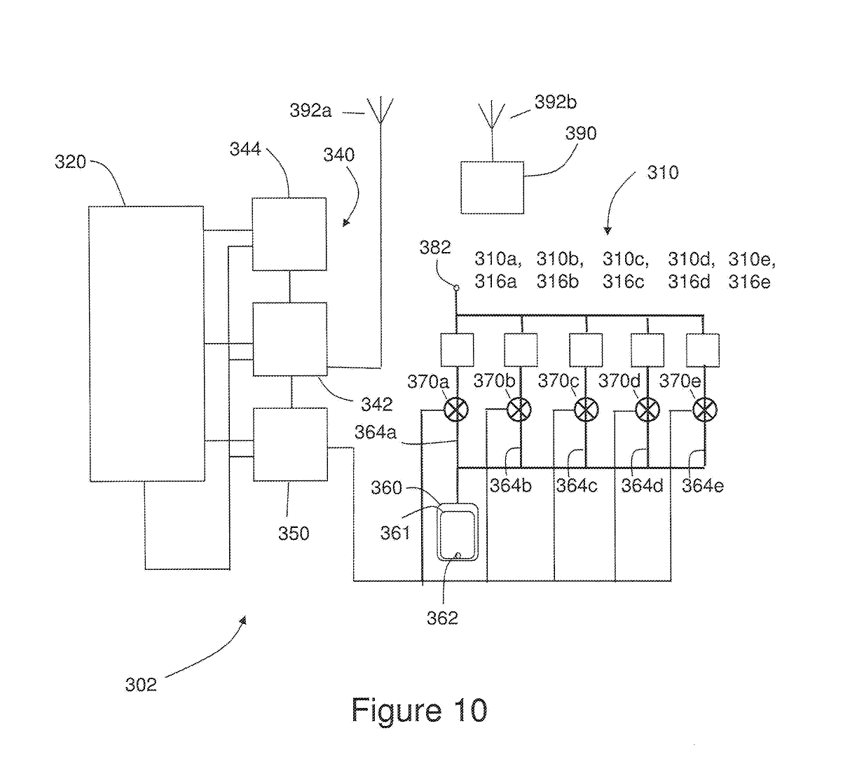

FIG. 10 shows a schematic system diagram of a third alternative elapsed time indicator 302 which shares many like features with the elapsed time indicator 2 of FIGS. 1-7(b). Like features of the elapsed time indicator 302 of FIG. 10 have the same reference numerals as the corresponding features of the elapsed time indicator 2 of FIGS. 1-7(b) incremented by “300”. Specifically, the elapsed time indicator 302 includes a display arrangement 310 which includes a plurality of display elements 310a, 310b, 310c, 310d and 310e. The elapsed time indicator 302 further includes an electrical source in the form of a flexible printed battery 320 and an electronic controller 340. The electronic controller 340 includes a programmable microcontroller 342, a clock crystal 344 and driver circuitry 350. Unlike the elapsed time indicator 2 of FIGS. 1-7(b), the microcontroller 342 is configured for bi-directional wireless communications with an external apparatus or handheld device 390. The microcontroller 342 may, for example, include an antenna 392a and the external apparatus 390 may include an antenna 392b for this purpose.

The external apparatus 390 may be used to program the microcontroller 342 with a first intermediate predetermined time period, a second intermediate predetermined time period, a third intermediate predetermined time period, a fourth intermediate predetermined time period and a fifth and final predetermined time period which may be selected according to the intended field of use of the elapsed time indicator 302. The fifth and final predetermined time period may, for example, represent a lifetime or a shelf-life of an item such as a perishable item with which the elapsed time indicator 302 is to be associated or to which the elapsed time indicator 302 is to be attached. The first, second, third, and fourth intermediate predetermined time periods may each represent a different predetermined proportion of the final predetermined time period. Unlike the elapsed time indicator 2 of FIGS. 1-7(b), the battery 320 is permanently connected to the microcontroller 342, the clock crystal 344 and the driver circuitry 350.

Unlike the elapsed time indicator 2 of FIGS. 1-7(b), the elapsed time indicator 302 includes a deformable reservoir membrane 361 located within a reservoir cavity 360 defined by a body (not shown) of the elapsed time indicator 302. The reservoir membrane 361 contains the fluid and is in fluid flow communication with a plurality of microfluidic channels 364a, 364b, 364c, 364d, 364e. The elapsed time indicator 302 further includes a reservoir vent 362 which extends from the environment external to the elapsed time indicator 302 to the reservoir cavity 230 and which is permanently open to permit air to flow from the external environment to the reservoir cavity 360. Similarly, the elapsed time indicator 302 further includes an indicator vent 382 which connects each of the porous elements 316a, 316b, 316c, 316d, 316e to the external environment and which is permanently open.

Unlike the elapsed time indicator 2 of FIGS. 1-7(b), the external apparatus 390 provides a wireless trigger signal to the microcontroller 342 whereupon the microcontroller 342 initiates a timer (not shown) according to a timing signal received from the clock crystal 344. In all other respects the operation of the elapsed time indicator 302 of FIG. 10 is identical to that of the elapsed time indicator 2.

Using the external apparatus 390 to wirelessly activate the elapsed time indicator 302 may avoid any need to apply a mechanical force for activation of the elapsed time indicator 302. Moreover, wireless activation may allow the external apparatus 390 to activate multiple elapsed time indicators 302 at the same time or at different times. In addition to displaying quantitative progressive visual elapsed time information as described above, the elapsed time indicator 302 may also wirelessly communicate the quantitative progressive elapsed time information to the external apparatus 390 for display or onward transmission or dissemination to one or more operators.

The elapsed time indicator 302 may include an environmental sensor (not shown) for measuring an environmental parameter which is configured for communication with the microcontroller 342. The microcontroller 342 may repeatedly receive measured values of the environmental parameter from the environmental sensor. The microcontroller 342 may be configured to wirelessly transmit an alarm signal to the external apparatus 390 when a measured value of the at least one environmental parameter falls outside a corresponding predetermined range. The environmental parameter may include at least one of temperature, pressure, humidity, pH, vibration, shock and position.

The microcontroller 342 may be configured to repeatedly adjust the final predetermined time period according to the measured values of the environmental parameter. This may allow the microcontroller 342 to account for any changes in a lifetime of an item with which the elapsed time indicator 302 is associated or to which the elapsed time indicator 302 is attached, which changes in the lifetime of the item may occur under different environmental conditions. For example, the elapsed time indicator 302 may include a temperature sensor and the microcontroller 342 may be configured to repeatedly adjust the final predetermined time period according to live temperature values measured using the temperature sensor to account for any changes in the lifetime of the item at the measured temperature values. Using such a time temperature integration method may allow the elapsed time indicator 302 to provide a more accurate indication of the time remaining to expiry of the lifetime of the item concerned.

The microcontroller 342 may be configured to wirelessly transmit a signal to the external apparatus 390 on expiry of any one or more of the intermediate predetermined time periods and the final predetermined time period. This may allow an external operator to monitor the time remaining until expiry of a lifetime or shelf-life of the item with which the elapsed time indicator 302 is associated or to which the elapsed time indicator 302 is attached.

The battery 320 may be rechargeable. The elapsed time indicator 302 may include an inductive coupling element (not shown) for inductive coupling with an inductive coupling element (not shown) of the external apparatus 390 for recharging of the battery 320. The antennas 392a and 392b may be used as the inductive coupling elements.

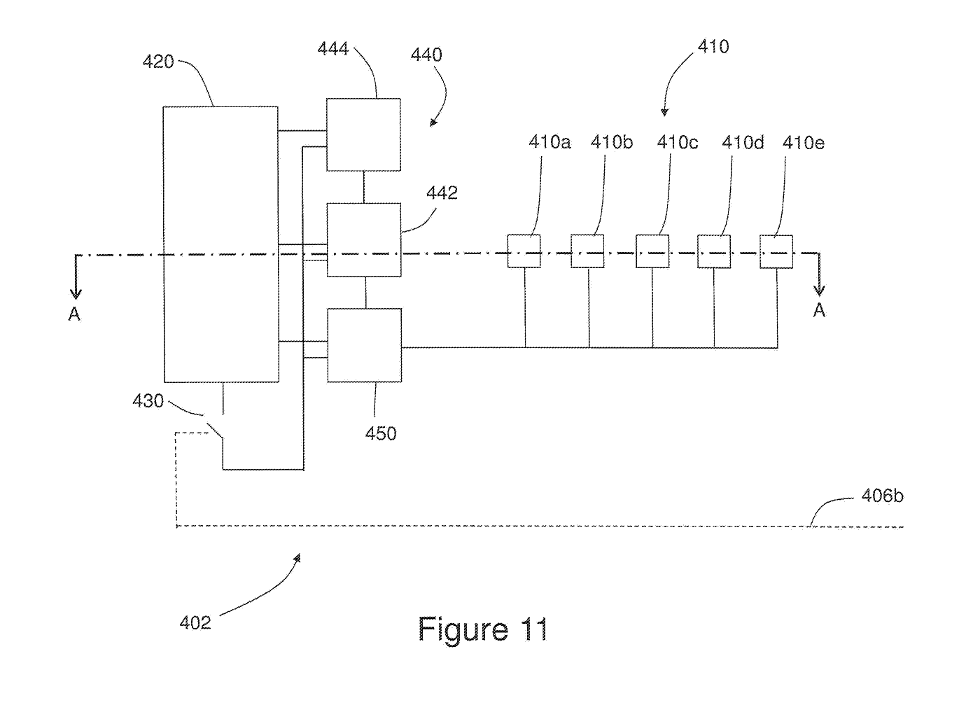

FIG. 11 shows a schematic system diagram of a fourth alternative elapsed time indicator 402 which shares many like features with the elapsed time indicator 2 of FIGS. 1-7(b). Like features of the elapsed time indicator 402 of FIG. 11 have the same reference numerals as the corresponding features of the elapsed time indicator 2 of FIGS. 1-7(b) incremented by “400”. Specifically, the elapsed time indicator 402 includes a display arrangement 410 includes a plurality of display elements 410a, 410b, 410c, 410d and 410e. Although not shown explicitly in FIG. 11, the first four display elements 410a, 410b, 410c, 410d are configured to selectively display a green colour, whereas the fifth display element 410e is configured to selectively display a red colour.

The elapsed time indicator 402 further includes an electrical source in the form of a flexible printed battery 420, a normally-open switch arrangement 430 and an electronic controller 440. The electronic controller 440 includes a programmable microcontroller 442, a clock crystal 444 and driver circuitry 450. The microcontroller 442 is programmed with a first intermediate predetermined time period, a second intermediate predetermined time period, a third intermediate predetermined time period, a fourth intermediate predetermined time period and a fifth and final predetermined time period which may be selected according to the intended field of use of the elapsed time indicator 402. The fifth and final predetermined time period may, for example, represent a lifetime or a shelf-life of an item such as a perishable item with which the elapsed time indicator 402 is to be associated or to which the elapsed time indicator 402 is to be attached. The first, second, third, and fourth intermediate predetermined time periods may each represent a different predetermined proportion of the final predetermined time period.

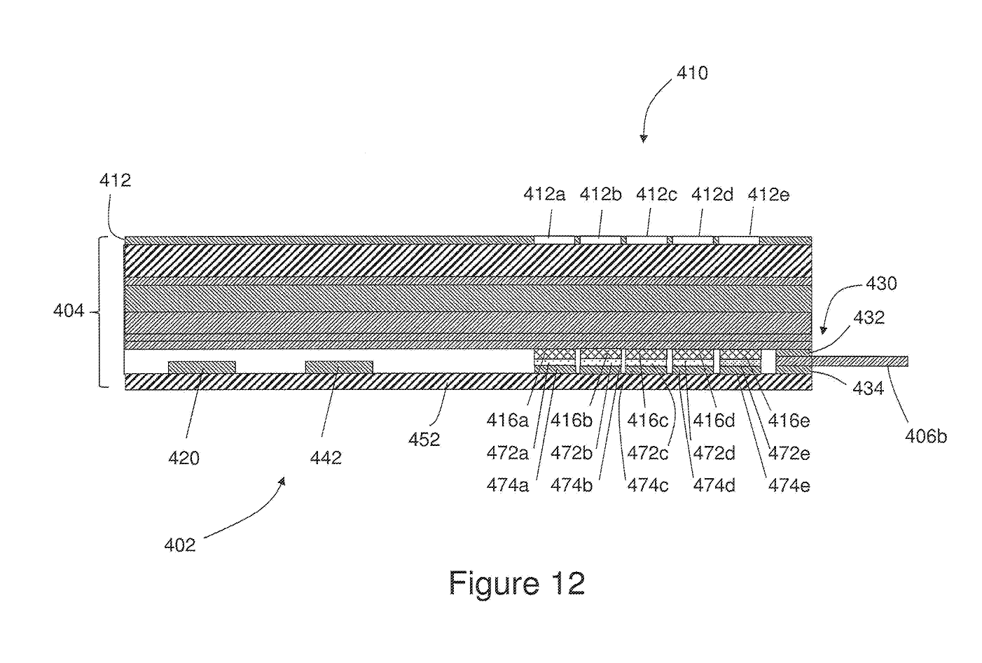

As shown in FIG. 12, the normally-open switch arrangement 430 includes a pair of electrical contacts 432, 434 which are biased mechanically towards one another. Prior to activation of the elapsed time indicator 402, an electrically insulating activation member 406b extends between the electrical contacts 432, 434 so as to prevent an electrical connection therebetween as shown in FIGS. 11 and 12 so that the battery 420 is initially disconnected from the microcontroller 442, the clock crystal 444 and the driver circuitry 450. The battery 420, the normally-open switch arrangement 430, the microcontroller 442, the clock crystal 444 and the driver circuitry 450 are all mounted on a flexible substrate 452. The flexible substrate 452 includes a plurality of electrical conductors such as metal tracks (not shown) which define electrical connections between the battery 420, the normally-open switch arrangement 430, the microcontroller 442 and the clock crystal 444 and the driver circuitry 450 so as to realise the electrical circuit shown schematically in FIG. 11.

As shown in FIG. 12, the body 404 of the elapsed time indicator 402 further includes a cover layer 412 which is generally opaque but which defines a plurality of transparent windows 412a, 412b, 412c, 412d and 412e extending through a thickness of the cover layer 412. Each display element 410a, 410b, 410c, 410d, 410e includes a corresponding one of the transparent windows 412a, 412b, 412c, 412d, 412e.

Each display element 410a, 410b, 410c, 410d, 410e further includes a corresponding heating element 474a, 474b, 474c, 474d, 474e, wherein each heating element 474a, 474b, 474c, 474d, 474e is mounted or formed, for example, by printing on the substrate 452.

Each display element 410a, 410b, 410c, 410d, 410e further includes a corresponding solid indicator agent 472a, 472b, 472c, 472d, 472e deposited, formed or located adjacent a corresponding heating element 474a, 474b, 474c, 474d, 474e. Although not shown explicitly in FIG. 12, it should be understood that the first four solid indicator agents 472a, 472b, 472c, and 472d are green, whereas the fifth solid indicator agents 472e is red. Each display element 410a, 410b, 410c, 410d, 410e further includes a corresponding porous element 416a, 416b, 416c, 416d, 416e located adjacent to, or is mounted on, a corresponding one of the solid indicator agents 472a, 472b, 472c, 472d, 472e. Each porous element 416a, 416b, 416c, 416d, 416e is initially opaque or substantially opaque. The body 404 of the elapsed time indicator 402 further includes various other layers located between the cover layer 412 and the porous elements 416a, 416b, 416c, 416d, 416e. Unless otherwise indicated below, it should be understood that these other layers are generally transparent and are generally non-porous and/or impervious to the fluid.

In use, the microcontroller 442 receives electrical power from the battery 420 and controls the heating elements 474a, 474b, 474c, 474d, 474e according to the result of a comparison between a timing signal received from the clock crystal 444 and the intermediate predetermined time periods and the final predetermined time period stored in the microcontroller 442 so as to provide a quantitative progressive visual indication towards the final predetermined time period. Activation is achieved by detaching the activation member 406b (represented schematically by the dashed line in FIG. 11) from the body 404. Specifically, detaching the activation member 406b allows the electrical contacts 432, 434 of the normally-open switch arrangement 430 to move into contact thereby activating the elapsed time indicator 402 by connecting the battery 420 to the microcontroller 442, the clock crystal 444 and the driver circuitry 450. Upon the microcontroller 442 receiving power from the battery 420, the microcontroller 442 initiates a timer (not shown) according to the timing signal received from the clock crystal 444. Immediately after activation, none of the display elements 410a, 410b, 410c, 410d, 410e is activated. Specifically, none of the heating elements 474a, 474b, 474c, 474d, 474e are operational.

On expiry of the first intermediate predetermined time period following activation, the microcontroller 442 controls the driver circuitry 450 causing the driver circuitry 450 to supply an electric current to the first heating element 474a causing the first solid green indicator agent 472a to melt and impregnate the first porous element 416a in a relatively short time period, typically of the order of minutes. On impregnation by the molten indicator agent 472a, the first porous element 416a becomes green and is visible through the corresponding first transparent window 412a and the intervening transparent or substantially transparent layers of the body 404.

Since the time taken for the molten indicator agent 472a to impregnate the first porous element 416a is only of the order of minutes and the first intermediate predetermined time period is generally a period of several hours or more, one of ordinary skill in the art will understand that the timing of the appearance of the molten indicator agent 472a is essentially determined by the microcontroller 442.

On expiry of the second intermediate predetermined time period following activation, the microcontroller 442 controls the driver circuitry 450 causing the driver circuitry 450 to supply an electric current to the second heating element 474b thereby causing the second solid green indicator agent 472b to melt and impregnate the second porous element 416b in a relatively short time period, typically of the order of minutes. On impregnation by the molten indicator agent 472b, the second porous element 416b becomes green and is visible through the corresponding first transparent window 412b and the intervening transparent or substantially transparent layers of the body 404.

Similarly, on expiry of the third and fourth intermediate predetermined time periods following activation, the microcontroller 442 causes the third and fourth solid green indicator agents 472c, 472d to melt and become visible through the corresponding third and fourth transparent windows 412c, 412d in a similar manner.

Similarly, on expiry of the fifth and final predetermined time period following activation, the microcontroller 442 causes the fifth and final solid red indicator agent 472e to melt and become visible through the corresponding fifth transparent window 412e. The appearance of the fifth and final red indicator agent 472e may then indicate that the lifetime or the shelf-life of the item with which the elapsed time indicator 402 is associated or to which the elapsed time indicator 402 is attached has expired.

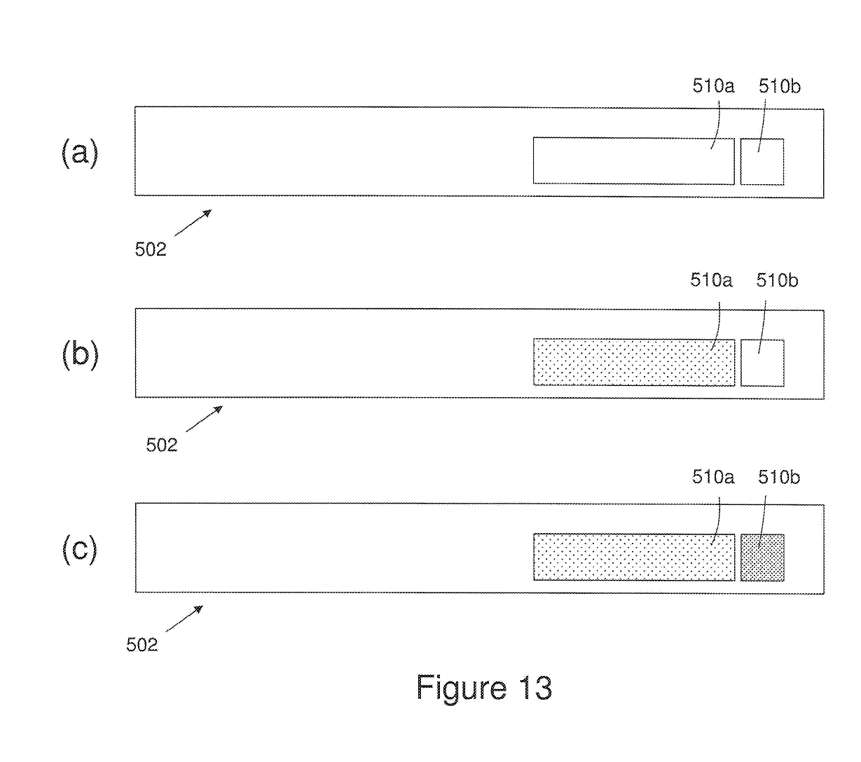

One of ordinary skill in the art will appreciate that various modifications to the elapsed time indicators described above are possible. For example, the number and arrangement of the display elements of the display arrangement may be different to those described above. For example, FIGS. 13(a)-13(c) represent schematic plan views of a fifth alternative elapsed time indicator 502 having a first longer display element 510a which is selectively activated to become green and a second and final shorter display element 510b which is selectively activated to become red. FIG. 13(a) shows the elapsed time indicator 502 immediately after activation, FIG. 13(b) shows the elapsed time indicator 502 after expiry of a first intermediate predetermined time period from activation, and FIG. 13(c) shows the elapsed time indicator 502 after expiry of a second final predetermined time period from activation. The second final predetermined time period may, for example, represent a lifetime or a shelf-life of an item such as a perishable item with which the elapsed time indicator 502 is to be associated or to which the elapsed time indicator 502 is to be attached. The first intermediate predetermined time period may represent a predetermined proportion of the second and final predetermined time period.

The cover layer 12 may be generally plain or uniform in colour, for example, white. One or more symbols, characters, letters, numbers or graphical representations may be printed or otherwise defined on an upper surface of the cover layer 12. In particular, one or more symbols, characters, letters, numbers or graphical representations may be printed or otherwise defined adjacent to each of the windows 12a, 12b, 12c, 12d, 12e, 12f.

The reservoir 60 may be defined by one or more layers according to the depth and/or volume of fluid required.

The elapsed time indicator 2 may include one reservoir for each porous element 16a, 16b, 16c, 16d, 16e, 16f, wherein each porous element 16a, 16b, 16c, 16d, 16e, 16f receives a fluid from a corresponding reservoir.

The microfluidic channels 64a, 64b, 64c, 64d, 64e may follow different paths. For example, the microfluidic channels 64a, 64b, 64c, 64d, 64e may be curved or even define a 180° bend. Such microfluidic channels may allow different arrangements of the reservoir 60 and the display arrangement 10 and/or different arrangements of the reservoir vent 62 and the indicator vent 82 according to the field of use. The reservoir vent 62 and the indicator vent 82 may located at one end of the body 4, along one side or edge of the body 4 or along an upper or lower surface of the body 4.

One or more of the valves 70a, 70b, 70c, 70d, 70e may be located anywhere between the reservoir 60 and the corresponding display elements 10a, 10b, 10c, 10d, 10e of the display arrangement 10 respectively. For example, the valve 70a shown in FIGS. 4(a) and 4(b) may be located at any position along the microfluidic channel 64a. Similar comments apply in relation to the positions of the valves 70b, 70c, 70d, 70e along the microfluidic channel 64b, 64c, 64d, 64e respectively.

The normally-open switch arrangement 30 may located at a position other than an the end 4a of the body 4. The normally-open switch arrangement 30 may located at the opposite end of the body 4, along one side or edge of the body 4 or along an upper or lower surface of the body 4.

In a further variant of the elapsed time indicator 2, rather than using a colourless or clear fluid to impregnate and render each porous element 16a, 16b, 16c, 16d, 16e transparent or more transparent and thereby reveal a corresponding underlying coloured indicator element 14a, 14b, 14c, 14d, 14e at an appropriate time following activation, a coloured fluid may be used instead to impart each porous element 16a, 16b, 16c, 16d, 16e with the colour of the coloured fluid at the appropriate time following activation. In such a further variant of the elapsed time indicator 2, the coloured indicator elements 14a, 14b, 14c, 14d, 14e may be omitted. Each porous element 16a, 16b, 16c, 16d, 16e may be connected to a different reservoir of fluid. Different reservoirs may have the same colour of fluid or different colours of fluid.

In a further variant of the elapsed time indicator 402 of FIGS. 11 and 12, the elapsed time indicator 402 may include a plurality of coloured indicator elements (not shown), each indicator element located between a corresponding one of the heating elements 472a, 472b, 472c, 472d, 472e and a corresponding one of the solid indicator agents 472a, 472b, 472c, 472d, 472e. The solid indicator agents 472a, 472b, 472c, 472d, 472e may be colourless or clear and, upon being melted by a corresponding heating element 472a, 472b, 472c, 472d, 472e, the molten indicator agents 472a, 472b, 472c, 472d, 472e may impregnate the porous elements 416a, 416b, 416c, 416d, 416e thereby causing the porous elements 416a, 416b, 416c, 416d, 416e to become transparent or more transparent thereby causing the underlying indicator elements to become visible or more visible.

1. An elapsed time indicator, comprising:
a porous element;
an electrical source; and
an electronic controller which is configured to:
receive electrical power from the electrical source; and
cause a fluid to be received by the porous element in response to expiry of a predetermined time period.

2. (canceled)

3. (canceled)

4. An elapsed time indicator according to claim 1, wherein upon receiving the fluid, the porous element is impregnated by the fluid.

5. An elapsed time indicator according to claim 1, wherein the fluid comprises at least one of an oil, a mixture of oils and silicon oil.

6. (canceled)

7. An elapsed time indicator according to claim 1, comprising a reservoir of the fluid, wherein the electronic controller is configured to control a flow of the fluid from the reservoir to the porous element on expiry of the predetermined time period.

8. (canceled)

9. (canceled)

10. An elapsed time indicator according to claim 7, comprising a microfluidic channel providing a fluid flow path from the reservoir to the porous element, the elapsed time indicator further comprising a valve which is configured to initially prevent the flow of the fluid from the reservoir along the microfluidic channel to the porous element and to selectively allow the flow of the fluid from the reservoir along the microfluidic channel to the porous element under the control of the electronic controller.

11. (canceled)

12. An elapsed time indicator according to claim 10, wherein the valve comprises a micro-valve and/or an electro-thermal valve.

13. An elapsed time indicator according to claim 10, wherein the valve comprises a movable valve member which is movable between a first configuration in which the valve member occludes the microfluidic channel and a second configuration in which the valve member allows the fluid to flow along the microfluidic channel.

14. An elapsed time indicator according to claim 13, wherein the valve comprises a heating element which is defined on or adjacent to the valve member and which extends at least part-way around a perimeter of the valve member when the valve member is in the first configuration.

15. An elapsed time indicator according to claim 14, wherein the heating element is operable so as to melt a portion of the valve member upon which the heating element is defined or to which the heating element is adjacent.

16. An elapsed time indicator according to claim 15, wherein the electronic controller selectively drives an electric current through the heating element so as to resistively heat the heating element and selectively melt the portion of valve member upon which the heating element is defined or to which the heating element is adjacent.

17. An elapsed time indicator according to claim 13, wherein the valve member is formed from a material which comprises at least one of a polymer, a parylene material, PET, PMMA, a wax and paraffin wax.

18. An elapsed time indicator according to claim 10, comprising a body which defines a cavity, which cavity defines and/or contains the reservoir of the fluid, the microfluidic channel and the porous element and wherein the cavity is initially sealed but is configured to be selectively exposed to an environment external to the elapsed time indicator.

19. (canceled)

20. (canceled)

21. An elapsed time indicator according to claim 18, wherein the body defines a reservoir vent extending from the cavity at a position at or adjacent to the reservoir and/or wherein the body defines an indicator vent extending from the cavity at a position at or adjacent to the porous element.

22. (canceled)

23. (canceled)

24. An elapsed time indicator according to claim 21, comprising at least one activation member detachably attached to the body so as to initially seal at least one of the reservoir vent and the indicator vent and wherein at least one of the reservoir vent and the indicator vent is unsealed by detaching the at least one activation member from the body.

25. (canceled)

26. (canceled)

27. An elapsed time indicator according to claim 24, wherein one of the reservoir vent and the indicator vent is permanently open and the other of the reservoir vent and the indicator vent is configured to be selectively unsealed to provide a flow path for air between the cavity and the environment external to the elapsed time indicator to thereby permit the fluid to flow from the reservoir towards the porous element.

28. An elapsed time indicator according to claim 1, comprising a solid agent located adjacent to or on the porous element and a heating element for melting the solid agent, wherein the electronic controller is configured to selectively activate the heating element so as to melt the solid agent and form the fluid in response to expiry of the predetermined time period.

29. (canceled)

30. (canceled)

31. An elapsed time indicator according to claim 1, wherein the fluid is colourless or clear and, upon impregnation by the fluid, the porous element becomes transparent or more transparent.

32. An elapsed time indicator according to claim 31, comprising an indicator element which becomes visible or more visible through the porous element when the porous element becomes transparent or more transparent, wherein the indicator element is coloured, green or red.

33. (canceled)

34. (canceled)

35. An elapsed time indicator according to claim 1, wherein the fluid is coloured, green or red.

36. (canceled)

37. An elapsed time indicator according to claim 1, comprising a plurality of porous elements, wherein the electronic controller is configured to cause a final porous element to receive a corresponding fluid in response to expiry of the predetermined time period and to cause each of the other porous elements to receive a corresponding fluid in response to expiry of a corresponding intermediate predetermined time period.

38. An elapsed time indicator according to claim 37, wherein each of the intermediate predetermined time periods is a predetermined proportion of the predetermined time period.

39. An elapsed time indicator according to claim 37, wherein upon receiving the corresponding fluid, each porous element is impregnated by the corresponding fluid.

40-51. (canceled)

52. A method for indicating an elapsed time, comprising
providing electrical power from an electrical source to an electronic controller; and
using the electronic controller to cause a fluid to be received by a porous element in response to expiry of a predetermined time period.

53. A method according to claim 52, comprising using the electronic controller to control the fluid to flow from a reservoir to the porous element in response to expiry of the predetermined time period.

54. A method according to claim 52, comprising using the electronic controller to selectively heat and melt a solid agent located adjacent to or on the porous element and form the fluid in response to expiry of the predetermined time period.
